(19) United States
(12) Patent Application Publication
(10) Pub. No.: US 2006/0015438 A1
(43) Pub. Date: Jan. 19, 2006

(54) System for linking initiators and beneficiaries, and method suited therefor

(76) Inventor: Matthias Kroner, Munich (DE)

Correspondence Address: DEAN D. SMALL;C/O ARMSTRONG TEASDALE LLP, ONE METROPOLITAN SQUARE, SUITE 2600, ST. LOUIS, MO, 63102-2740, US

(21) Appl. No.: 11/036,535

(22) Filed: Jan. 14, 2005

(30) Foreign Application Priority Data
Jul. 16, 2004 (DE) 102004034467.1

(51) Int. Cl. G06Q 40/00

(52) U.S. Cl. 705/37

(57) ABSTRACT

A system for linking initiators and beneficiaries, and a method suited therefor, are provided in which a linking unit is provided, which provides an agreement concluded between the initiator and the beneficiary, whereby the agreement is concluded earmarked for a certain product. A first mediation unit for an interested party is provided, which party will provide the product to the beneficiary after the performance of the agreement, in order to be able to use existing financial means in a target-oriented fashion.

### CROSS REFERENCE TO RELATED APPLICATIONS

This application claims the benefit of German Application 102004 034 467.1 filed Jul. 16, 2004.

### BACKGROUND OF THE INVENTION

The present invention relates to a system for linking initiators and beneficiaries, and a method suited therefor.

Conventionally, a beneficiary or an initiator lacking the financial means to directly purchase a product begin to save financial contributions for an extended period of time in order to acquire the desired product at a later point in time. However, in the course of the extended saving period it often happens that the saved financial means are recalled prematurely such that the desired product cannot be acquired. In these cases, it can happen that the saver gets into debt in order to still be able to acquire the desired product. This process of getting into debt is enhanced especially by the dealers or manufacturers of products offering to an increasing degree products that are available through financing and by the banks and savings banks easily approving so-called consumer loans. Moreover, there is a risk that the interest rate might increase during the term of the loan and thus become a substantial additional financial burden.

### BRIEF DESCRIPTION OF THE INVENTION

Various embodiments of the invention provide a system and a method allowing a saver or beneficiary or initiator to utilize existing financial means in a target-oriented fashion.

According to an embodiment of the invention, a linking unit is provided which makes available an agreement concluded between the initiator and the beneficiary, whereby the initiator and the beneficiary preferably conclude an agreement earmarked for a product. This measure ensures that financial means, which have been saved or exist for an extended period of time, cannot be recalled prematurely, because the agreement stipulates that any special benefits do not go to the beneficiary and/or initiator otherwise. The earmarking also provides for reasonable financial planning, which allows especially young beneficiaries a clearly structured entry into the world of finance. If, in addition, a first mediation unit for an interested party is provided, which interested party is to provide the product to the beneficiary after performance of the agreement, then the existing linkage of initiators and beneficiaries activates a target group of manufacturers as interested parties, which is also enabled to respond to the need for products at an early point in time and can produce these in a cost-efficient fashion. Therefore, a regular financial process is provided, which is easy to comprehend for each participating party, (e.g. beneficiary, initiator or interested party), which is especially helpful in the highly complex nature of the world of finance. The simplicity should also make the regularity of the financial flow transparent.

Guiding, for instance, the residual value of the product after use of the product to the linking unit by a second mediation unit allows a product marketed by means of the first mediation unit to become the basis for the acquisition of another product. This measures provides an advantage in particular in that existing financial goods are not removed from the financial cycle, but recycled to thus keep the respective sector of the economy going by means of the consumer goods cycle. Another advantage thus achieved is that the financial means entered into the system may shorten the period of time until the acquisition of another product.

In various embodiments of the invention, the linking unit includes a financial service product, for example in the form of continued saving or continued depositing of financial means in a fund, whereby the initiator and/or beneficiary can make at least a proportionate financial contribution and/or goods contribution. A goods contribution may be entered into the system or method, because this activates unused capital goods, which otherwise were useless to the initiator and/or beneficiary.

If the financial contributions of the initiator and/or beneficiary are made available in a periodical fashion, a regularity is thereby defined which is calculable for all involved parties.

If the first and/or the second mediation unit are an auction or a call for tender, either provides simple means for the existing products to achieve an adequate current value or optimal current value.

Defining the product in more concrete terms during the term of the agreement provides the basis for flexibility such that the system or method according to various embodiments of the invention can be concluded early, for example, at a young age in as far as it concerns young beneficiaries.

If, in addition, a beneficiary data base is provided, (e.g., an overview of the future beneficiaries), multiple interested parties can secure for themselves the sale of their product just as early by submitting an offer, which again is associated with cost-efficiency in the manufacture of the product.

It has proven to be advantageous to provide for the opportunity of a partial amount of the financial service product to be made available from a bonus program by a third parties, since this allows the beneficiary to acquire the desired product at an early point in time.

It is also advantageous to regulate the sale of the product and the purchase of a used product in a so-called purchase and sale agency, since this detour simplifies the procedural steps of the system and thus renders both the purchase and the sale efficient.

In addition, it is also advantageous if for example the initiator agrees to make an additional financial contribution, the amount of which depends on the financial contributions made by the beneficiary according to a fixed formula. This formula can for instance specify that the initiator increases his financial contribution by 100% or 50% or 25% once a certain defined point in time is reached. This obligation of the initiator with respect to the beneficiary can also entail that an additional financial contribution is due provided the beneficiary abstains from recalling or withdrawing any contributions made, preferably for a defined fixed period of time. Another type of obligation can be one, in which the initiator agrees to round up the financial contributions made by the beneficiary once certain goals are attained.

### BRIEF DESCRIPTION OF THE DRAWINGS

FIG. 1 is a flow diagram of a linking system constructed according to various embodiment of the present invention.

FIG. 2 is a chart illustrating a total overview of a business model according to various embodiments of the present invention.

### DETAILED DESCRIPTION OF THE INVENTION

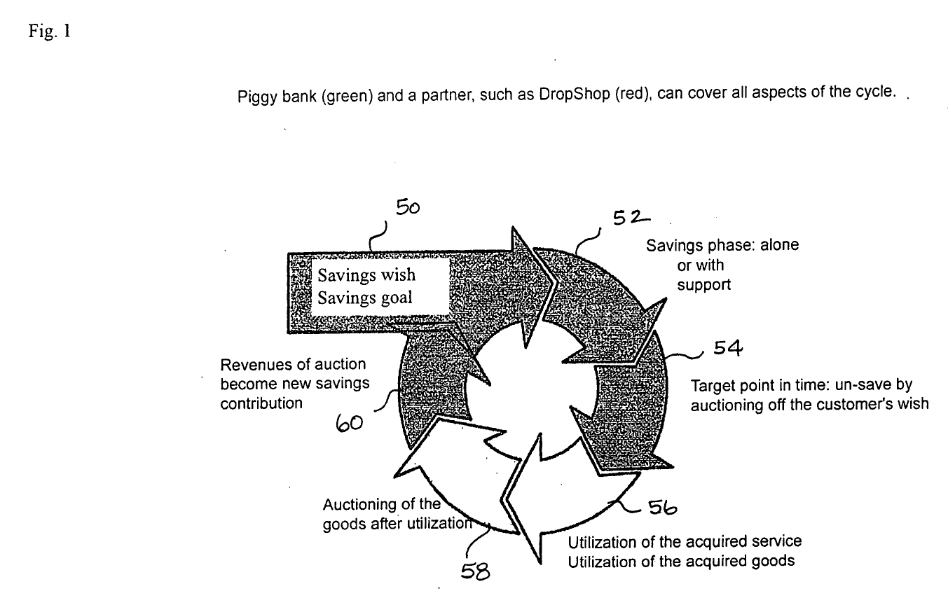

FIG. 1 shows the procedural steps of a system, including cycle linking initiators and beneficiaries, using and/or initiated by a savings plan as the linking unit. Based on an existing savings wish or savings goal at 50, financial means are accrued for an extended period of time at 52 during the savings phase either alone or with support, which are acquired at 54 at a later target point in time by the beneficiary, for example, through an auction as the first mediation unit of multiple interested parties. This can be performed by means of a first mediation unit, for example an auction or call for tender. After utilization of the acquired goods or product at 58, a second mediation unit, which can also be an auction or a call for tender, can be used to capitalize the product with the revenues from the auction serving as the base capital for saving up for another product at 60. This completes the cycle.

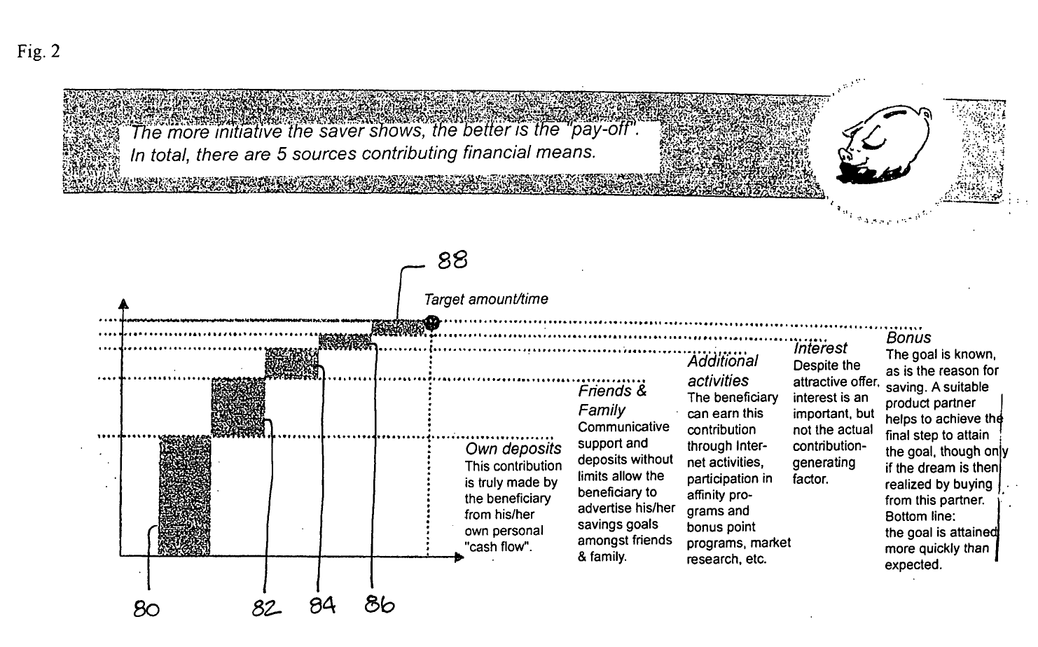

FIG. 2 is a chart illustrating a total overview of an embodiment of a business model of the present invention. The business model commences with a base amount 80 which is contributed for example in the form of a non-cash contribution placed with the financial service provider and comprises the so-called self-contribution. Another component 82 includes contributors from, for example, friends and family. This component 82 may also make a non-cash contribution or contribute a fixed amount of money to the system. In addition, the beneficiary receives from the initiator and/or financial service provider a financial contribution as compensation for advertising measures amongst family and friends. Another component 84 includes contributions through different programs (e.g., Internet affinity programs and bonus point programs, market research, etc.), Another component 86 is interest on accumulated contributions. Another component 88 is the financial contribution increases due to existing bonus point systems. After the method runs for a certain time, the interest accrued may contribute to an increase of the financial contribution. However, if the use of the funds for the product is fixed at an early time due to the earmarking feature, the resulting competition between different interested parties, or product partners, can lower the sales price below the market price. In other words, the method provides a bonus to the beneficiary that is advantageous as compared to a relationship between one beneficiary and one interested party.

The system and method according to the various embodiments of the invention also provides the additional advantage that, for example, everyday objects, which were acquired by the beneficiary, for example, due to the earmarking feature by means of the system or method described herein, are recapitalized and an opportunity is created for the beneficiary to contribute these to the capital flow for the acquisition of desired products in the future.

Thus, an opportunity is provided according various embodiments of the invention that allows the beneficiary to utilize his everyday objects effectively for future consumption desires while requiring no major self initiative, (e.g., enacting the sale, locating buyers, etc.). For this purpose, the operator of the system only needs to take over for the beneficiary the value added measures with regard to objects that are useless to the beneficiary by providing the logistics in the form of storage warehouses and contact points, whereby the beneficiary can provide optimal value to the beneficiary because of the focussed and effective marketing of everyday objects.

1. A system for linking initiators and beneficiaries, comprising:
a) a linking unit, providing an agreement concluded between the initiator and the beneficiary, the agreement concluded earmarked for a product; and
b) a first mediation unit for an interested party, the interested party providing the product to the beneficiary after the performance of the agreement.

2. A system according to claim 1, wherein a residual value of the product after utilization of the product is guided to the linking unit by a second mediation unit.

3. A system according to claims 1, wherein the linking unit comprises a financial service product, in which at least one of the initiator and the beneficiary make at least a proportionate financial contribution and/or goods contribution.

4. A system according to claim 3, wherein at least one of the financial contributions of the initiator and the beneficiary are made available periodically.

5. A system according to claim 2, wherein at least one of the first and second mediation units comprise an auction or call for tender or bids.

6. A system according to claim 1, wherein the product is defined in more specific terms during the term of the agreement.

7. A system according to claim 1, further comprising a beneficiary database provided to the interested parties.

8. A system according to claim 3, wherein a partial amount of the financial service product is made available by third parties from a bonus program.

9. A system according to claim 8, wherein a partial amount of the initiator is made available to the financial service product over a long-term and a partial amount of the beneficiary is made available to the financial service product over a short-term.

10. System according to claim 1, wherein mediation of the product is performed for commission.

11. A system according to claim 1, wherein a purchase of the product by the beneficiary and the purchase of a used product are regulated in a purchase and sale agency.

12. A method for linking initiators and beneficiaries said method comprising:
a) providing a linking unit having an agreement concluded between the initiator and the beneficiary, the agreement concluded and earmarked for a product; and
b) mediating the product to an interested party, the interested party providing the product to the beneficiary after the performance of the agreement.

13. A method according to claim 12, wherein a current value of the product after utilization is determined and made available again to the initiator as base capital.

14. A method according to claims 12, wherein the initiator is obligated with respect to the beneficiary to make an additional financial contribution, the amount of the contribution based on the financial contributions made by the beneficiary according to a predetermined formula.

15. A method according to claim 12, wherein the initiator is obligated with respect to the beneficiary to make an additional financial contribution when the benificiary has not withdrawn any contributions for a predetermined period of time.

16. A method according to claim 12, wherein the initiator is obligated with respect to the beneficiary to make an additional financial contribution including collecting current financial contributions.

17. A method according to claim 12, further comprising a logistics center wherein at least one of the products are stored and the value of the products are determined.

18. A method to acquire one of a good or service, said method comprising:
accumulating funds over a period of time;
offering for one of a good and service the accumulated funds to a plurality of parties via a mediator unit;
providing the accumulated funds to one of the plurality of parties providing one of the good and service;
using one of the good or service;
offering the used good or service to a plurality of parties via a second mediation unit; and
receiving funds from a party acquiring the good or service, the finds becoming a contribution to the accumulated funds.

19. A method according to claim 18, wherein the first and second mediator units comprise at least one of an auction or call for tender.

20. A method according to claim 19, wherein accumulating funds comprises acquiring funds from at least one of self-deposits, third parties, additional activities, interest and a bonus points system.
